(19) United States
(12) Patent Application Publication
(10) Pub. No.: US 2022/0021969 A1
(43) Pub. Date: Jan. 20, 2022

(54) WATERPROOF MICROPHONE

(71) Applicant: HOSIDEN CORPORATION, Osaka (JP)

(72) Inventors: Tsutomu MATSUSHITA, Fukuoka (JP); Hiroyuki HARANO, Fukuoka (JP); Ryuji AWAMURA, Fukuoka (JP); Kensuke NAKANISHI, Fukuoka (JP)

(73) Assignee: HOSIDEN CORPORATION, Osaka (JP)

(21) Appl. No.: 17/371,658

(22) Filed: Jul. 9, 2021

(30) Foreign Application Priority Data
Jul. 16, 2020 (JP) 2020-122086

(51) Int. Cl. H04R 1/44; H04R 1/02

(52) U.S. Cl. CPC H04R 1/44; H04R 1/02

(57) ABSTRACT

The waterproof microphone according to the present invention comprises: a case that includes a partition wall separating an internal space into two chambers, a front chamber and a rear chamber, a hole in the partition wall for allowing communication between the front chamber and the rear chamber, and opening portions in surfaces of the front chamber and the rear chamber that face the partition wall; a waterproof vibrating membrane covering the opening portion of the front chamber; a microphone unit attached to a surface of the partition wall on the rear chamber side; and a sealing member sealing the opening portion of the rear chamber and including an air hole allowing communication between the rear chamber and an external space.

### TECHNICAL FIELD

The present invention relates to a waterproof microphone.

### BACKGROUND ART

Japanese Patent Publication No. S53-039766 (referred to as Patent Literature 1, hereinafter) is an example of a conventional technique of a drip-proof structure for an audio component storage box.

The audio component storage box of Patent Literature 1 realizes a complete watertight, airtight structure for a room inside a case by fixing a waterproof vibrating diaphragm of a speaker and waterproof packing in such a manner as to cover a sound emission hole (Patent Literature 1).

The problem pertaining to this conventional waterproof microphone is either insufficient waterproofing property and durability due to an attempt to ensure sufficient acoustic characteristics, or insufficient acoustic characteristics due to an attempt to ensure sufficient waterproofing property and durability.

### SUMMARY OF THE INVENTION

An object of the present invention is to provide a waterproof microphone capable of achieving both acoustic characteristics and waterproofing property/durability.

A waterproof microphone according to the present invention includes a case, a waterproof vibrating membrane, a microphone unit, and a sealing member.

The case includes a partition wall that separates an internal space into two chambers, a front chamber and a rear chamber. The partition wall includes a hole that allows communication between the front chamber and the rear chamber. Surfaces of the front chamber and the rear chamber that face the partition wall each include an opening portion. The waterproof vibrating membrane covers the opening portion of the front chamber. The microphone unit is attached to a surface of the partition wall on the rear chamber side. The sealing member seals the opening portion of the rear chamber and includes an air hole that allows communication between the rear chamber and an external space.

### EFFECTS OF THE INVENTION

The waterproof microphone of the present invention is capable of achieving both acoustic characteristics and waterproofing property/durability.

### BRIEF DESCRIPTION OF THE DRAWINGS

FIG. 1 is a schematic cross-sectional diagram of a waterproof microphone of Example 1;

FIG. 2 is a schematic cross-sectional diagram of a waterproof microphone of Example 2;

FIG. 3 is a schematic cross-sectional diagram of a waterproof microphone of Example 3;

FIG. 4 is a schematic cross-sectional diagram taken along line 4-4 of the waterproof microphone of Example 3; and

FIG. 5 is a schematic cross-sectional diagram of a waterproof microphone of a modification of Example 3.

### DETAILED DESCRIPTION

Embodiments of the present invention are now described hereinafter in detail. Note that components with the same function are denoted by the same reference numerals; overlapping explanations are omitted accordingly.

### EXAMPLE 1

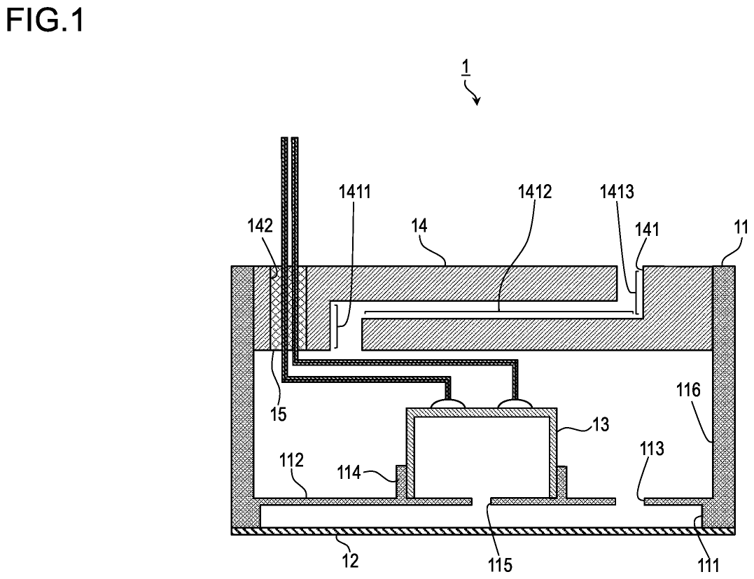

A structure of a waterproof microphone of Example 1 is described hereinafter with reference to FIG. 1. As shown in the diagram, a waterproof microphone 1 of the present example includes a case 11, a waterproof vibrating membrane 12, a microphone unit 13, a sealing member 14, and a filling member 15. FIGS. 1 to 3 each omit the illustration of an internal structure of the microphone unit 13.

<Case 11>

The case 11 includes a partition wall 112 partitioning an internal space of the case 11 into two chambers, a front chamber 111 and a rear chamber 116. A hole 113 that allows communication between the front chamber 111 and the rear chamber 116 is formed on the partition wall 112. An opening portion is formed on each of surfaces of the front chamber 111 and the rear chamber 116 that face the partition wall 112. The case 11 may be made of metal such as aluminum, resin, or other materials. In a case where the microphone unit 13 is an ECM, a substrate of the ECM corresponds to the partition wall 112.

<Waterproof Vibrating Membrane 12>

The waterproof vibrating membrane 12 covers the opening portion of the front chamber 111. The waterproof vibrating membrane 12 may be a metallic membrane, a Teflon membrane, a rubber membrane, film, or the like. Because a metallic membrane, a Teflon membrane, a rubber membrane, film or the like can be used as a vibrating plate and vibrations thereof can be received with an internal microphone (the microphone unit 13), a tone hole is omitted. Note that the waterproof vibrating membrane 12 may be a metallic or resin thin film that does not corrode easily. Acoustic characteristics of the waterproof microphone 1 can be adjusted by changing a thickness and an effective diameter of the waterproof vibrating membrane 12 and a volume of the front chamber 111.

<Microphone Unit 13>

The microphone unit 13 is attached to a surface of the partition wall 112 on the rear chamber 116 side. A support member 114 supporting the microphone unit 13 is formed on the surface of the partition wall 112 on the rear chamber 116 side. A hole 115 is formed in a lower portion of the microphone unit 13. The microphone unit 13 may be a typical ECM, MEMS microphone, or the like.

<Sealing Member 14>

The sealing member 14 seals the opening portion of the rear chamber 116 and includes an air hole 141 that allows communication between the rear chamber 116 and an external space. The air hole 141 is a hole that extends while bending multiple times in the sealing member 14. For example, as shown in the diagram, the air hole 141 is configured by a first vertically stretched portion 1411 communicating with the rear chamber 116 and extending vertically upward, a horizontally stretched portion 1412 connected to the first vertically stretched portion 1411 and extending in a horizontal direction, and a second vertically stretched portion 1413 connected to the horizontally stretched portion 1412, extending vertically upward, and communicating with the external space. By reducing an inner diameter of the air hole 141 and bending the air hole 141 multiple times as described above to increase a total length thereof, an acoustic impedance can be increased. Accordingly, a sound from the outside is prevented from entering, coping with fluctuations of an internal air pressure. A wiring hole 142 is also formed in the sealing member 14.

<Filling Member 15>

A cable is inserted into the wiring hole 142, and then the wiring hole 142 is filled with the filling member 15, thereby sealing the wiring hole 142.

By allowing ting the front chamber 111 and the rear chamber 116 to communicate with the external space, an abnormal alteration of the waterproof vibrating membrane 12 caused by pressure fluctuations due to changes in temperature and altitude can be prevented. Accordingly, not only is it possible to realize the waterproof microphone 1 that does not break down or deteriorate easily even under bad weather conditions, but also such waterproof microphone 1 can be applied to, for example, a microphone attached to the outside of an automobile.

Also, since the acoustic impedance can be increased by the air hole 141, the impact on the characteristics of the microphone unit 13 can be reduced. By reducing the diameter of the air hole 141 and bending the air hole 141 multiple times in the sealing member 14 as in the example shown in FIG. 1, the waterproof microphone 1 can deal with the pressure fluctuations without impairing the waterproofing property of the waterproof microphone 1.

Since the waterproof microphone 1 of the present example can be realized simply by providing the hole 113 in the partition wall 112 and preparing the sealing member 14 described above, an existing electret condenser microphone and the like can be applied as-is, thereby reducing the cost.

### EXAMPLE 2

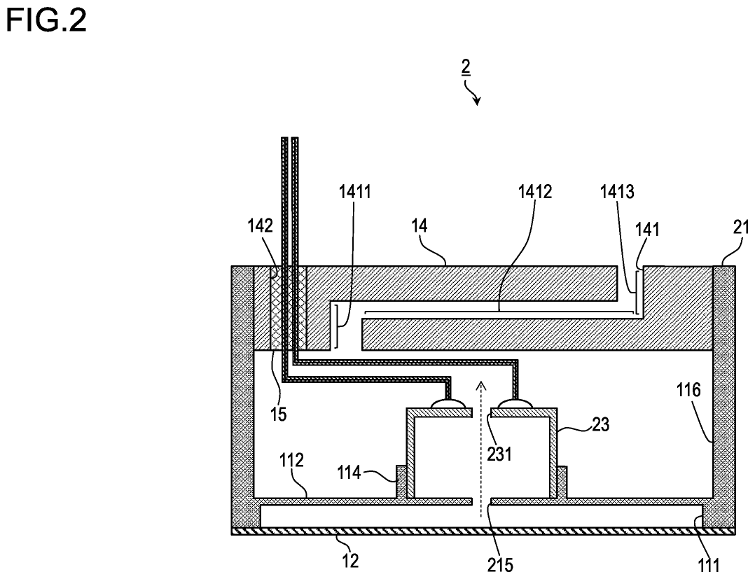

A structure of a waterproof microphone of Example 2 is described hereinafter with reference to FIG. 2. As shown in the diagram, a waterproof microphone 2 of the present example includes the case 21, the waterproof vibrating membrane 12, a microphone unit 23, the sealing member 14, and the filling member 15. The case 21 and the microphone unit 23 are the only components with structures different from those of Example 1. The structures of the case 21 and the microphone unit 23 are described hereinafter.

<Case 21>

In the case 21, a hole 215 is provided in a position at a lower portion of the microphone unit 23 that is covered by the microphone unit 23. The hole 215 plays a role equivalent to the hole 113 of Example 1. Therefore, the hole 113 is not formed in the case 21.

<Microphone Unit 23>

The microphone unit 23 includes a small hole 231 that penetrates from the front chamber 111 side to the rear chamber 116 side or from the rear chamber 116 side to the front chamber 111 side. In a case where the microphone unit 23 is a MEMS microphone, it is preferred that the small hole 231 be provided in an upper surface of the microphone unit 23. A ventilation path (shown by a dashed arrow in the diagram) that allows communication between the front chamber 111 and the rear chamber 116 is formed by the small hole 231 and the hole 215.

<<Effects>>

According to the waterproof microphone 2 of the present example, eliminating the hole 113 can prevent the sound from entering, thereby reducing the impact on the characteristics of the microphone unit 23.

### EXAMPLE 3

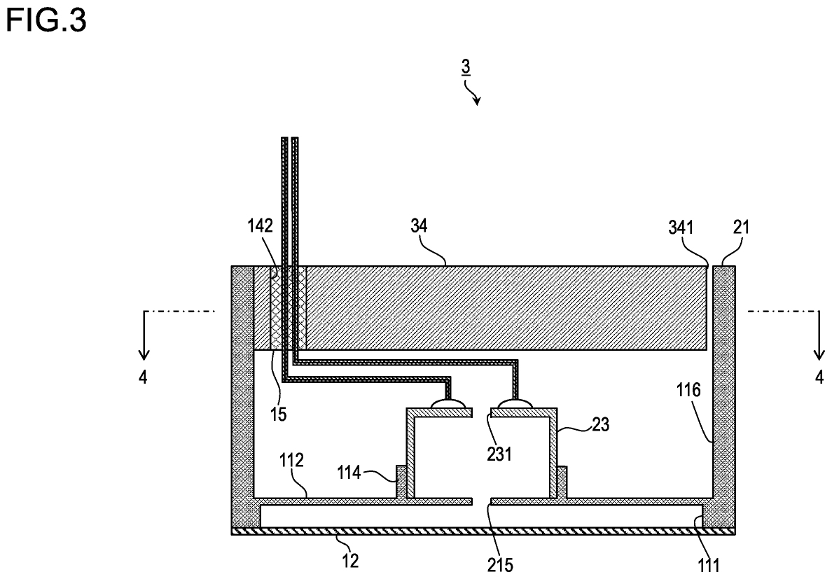

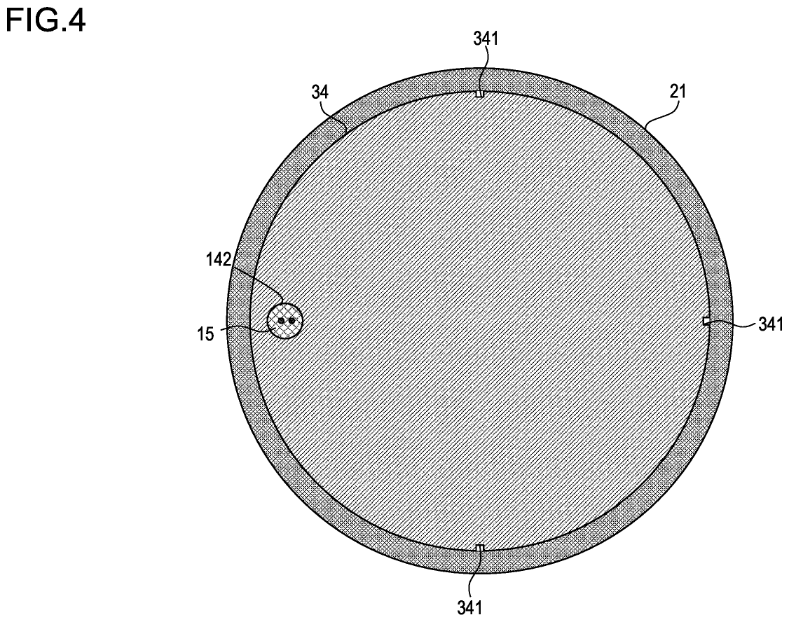

A structure of a waterproof microphone of Example 3 is described hereinafter with reference to FIGS. 3 and 4. As shown in FIG. 3, a waterproof microphone 3 of the present example includes the case 21, the waterproof vibrating membrane 12, the microphone unit 23, a sealing member 34, and the filling member 15. The sealing member 34 is the only component with a structure different from that of Example 2. The structure of the sealing member 34 is described hereinafter.

<Sealing Member 34>

An air hole 341 is formed on a side surface of the sealing member 34 (a surface in contact with an inner surface of the case 21). The air hole 341 is a groove stretched in the vertical direction on the side surface of the sealing member 34 so as to allow communication between the rear chamber 116 and the external space (a groove with a depth of approximately 10 μm. See 341 in FIGS. 3 and 4). As shown in FIG. 4, the air hole 341 may be provided in a plurality of sections.

[Modifications]

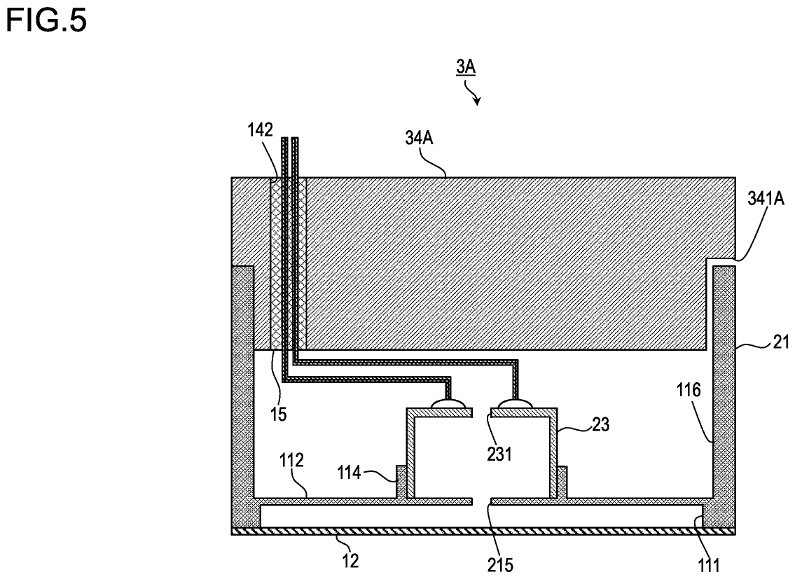

A structure of a waterproof microphone of a modification of Example 3 is described hereinafter with reference to FIG. 5. As shown in FIG. 5, a waterproof microphone 3A of the present modification includes the case 21, the waterproof vibrating membrane 12, the microphone unit 23, a sealing member 34A, and the filling member 15. The sealing member 34A is the only component with a structure different from that of Example 3. The structure of the sealing member 34A is described hereinafter.

<Sealing Member 34A>

The sealing member 34A of the present modification is formed so as to cover an edge surface of the opening portion of the rear chamber 116 (see FIG. 5), wherein an air hole 341A is an L-shaped groove that is formed on a surface that is in contact with a side surface of the sealing member 34A and the edge surface of the opening portion of the rear chamber 116.

[Other Modification]

To obtain a combination not disclosed in FIGS. 1 to 5, for example, the case 11, the microphone unit 13, and the sealing member 34 (or the sealing member 34A) may be combined.

<<Effects>>

Since the air hole 341 (air hole 341A) can be formed as a groove in the sealing member 34 (sealing member 34A) by means of processing that is finer than that performed in puncturing the sealing member, not providing a bending portion does not lead to deterioration of the waterproofing property.

Since the air hole 341 (air hole 341A) is formed into the shape described above, the groove can be provided when molding the sealing member 34 (sealing member 34A), resulting in reducing the number of steps as compared with when puncturing the sealing member later.

Although the sealing member needs to be divided into a plurality of parts and molded in order to provide the sealing member with the air hole having a bending portion, the sealing member can be integrated by forming the air hole 341 (air hole 341A) into the shape described above, thereby achieving the cost reduction.

What is claimed is:

1. A waterproof microphone, comprising:
a case that includes a partition wall separating an internal space into two chambers, a front chamber and a rear chamber, a hole in the partition wall for allowing communication between the front chamber and the rear chamber, and opening portions in surfaces of the front chamber and the rear chamber that face the partition wall;
a waterproof vibrating membrane covering the opening portion of the front chamber;
a microphone unit attached to a surface of the partition wall on the front chamber side;
and a sealing member sealing the opening portion of the rear chamber and including an air hole allowing communication between the rear chamber and an external space.

2. The waterproof microphone according to claim 1, wherein the air hole is a hole that extends while bending multiple times in the sealing member.

3. The waterproof microphone according to claim 1, wherein the air hole is a groove that is formed on a side surface of the sealing member.

4. The waterproof microphone according to claim 1, wherein the sealing member is formed so as to cover an edge surface of the opening portion of the rear chamber, and the air hole is a groove that is formed on a surface that is in contact with a side surface of the sealing member and the edge surface.

5. The waterproof microphone according to claim 1, wherein the microphone unit includes a small hole that penetrates from the front chamber side to the rear chamber side or from the rear chamber side to the front chamber side, the hole is provided in a position covered by the microphone unit, and a ventilation path allowing communication between the front chamber and the rear chamber is formed by the small hole and the hole.

6. The waterproof microphone according to claim 2, wherein the microphone unit includes a small hole that penetrates from the front chamber side to the rear chamber side or from the rear chamber side to the front chamber side, the hole is provided in a position covered by the microphone unit, and a ventilation path allowing communication between the front chamber and the rear chamber is formed by the small hole and the hole.

7. The waterproof microphone according to claim 3, wherein the microphone unit includes a small hole that penetrates from the front chamber side to the rear chamber side or from the rear chamber side to the front chamber side, the hole is provided in a position covered by the microphone unit, and a ventilation path allowing communication between the front chamber and the rear chamber is formed by the small hole and the hole.

8. The waterproof microphone according to claim 4, wherein the microphone unit includes a small hole that penetrates from the front chamber side to the rear chamber side or from the rear chamber side to the front chamber side, the hole is provided in a position covered by the microphone unit, and a ventilation path allowing communication between the front chamber and the rear chamber is formed by the small hole and the hole.
